(19) United States
(12) Patent Application Publication
(10) Pub. No.: US 2025/0220498 A1
(43) Pub. Date: Jul. 3, 2025

(54) METHOD TO CONTINUE STREAM CLASSIFICATION SERVICE (SCS) IN ROAMING ACROSS ACCESS POINTS (APS) IN AN EXTENDED SERVICE SET (ESS)

(71) Applicant: Cisco Technology, Inc., San Jose, CA (US)

(72) Inventors: Jegan Manoharan, Bangalore (IN); Venkat Chirreddy, Milpitas, CA (US); Sanjay Katabathuni, Fremont, CA (US); Sachin D. Wakudkar, St. Sulpice (CH)

(73) Assignee: Cisco Technology, Inc., San Jose, CA (US)

(21) Appl. No.: 19/005,498

(22) Filed: Dec. 30, 2024

(30) Foreign Application Priority Data
Dec. 29, 2023 (IN) 202341089796

(51) Int. Cl. H04W 28/02; H04L 47/24; H04W 28/10

(52) U.S. Cl. CPC H04W 28/0268; H04L 47/24; H04W 28/10

(57) ABSTRACT

A method to continue Stream Classification Service (SCS) in roaming across Access Points (APs) in an Extended Service Set (ESS) may be provided. A first AP of the ESS may receive a SCS request from a station for a SCS flow. The SCS request may include a SCS identifier for the SCS flow and Quality of Service (QoS) resources requested for the SCS flow. The first AP may configure the QoS resources for the SCS flow at the first AP. A second AP of the ESS may receive a re-association request from the station in response to the station roaming to the second AP. The second AP may configure the QoS resources for the SCS flow at the second AP based on the re-association request.

### RELATED APPLICATION

Under provisions of 35 U.S.C. § 119(e), Applicant claims the benefit of Indian Provisional Application No. 202341089796 filed Dec. 29, 2023, which is incorporated herein by reference.

### TECHNICAL FIELD

The present disclosure relates generally to a method to continue stream classification service in roaming across Access Points (APs) in an Extended Service Set (ESS).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is an operating environment for a method to continue Stream Classification Service (SCS) in roaming across Access Points (APs) in an Extended Service Set (ESS);

FIG. 2 is a flow chart of a method to continue SCS in roaming across APs in an ESS;

FIG. 3A and FIG. 3B illustrate roaming of a station in an ESS;

FIG. 4 illustrates an example SCS descriptor element; and

FIG. 5 is a block diagram of a computing device.

### DETAILED DESCRIPTION

### Overview

A method to continue Stream Classification Service (SCS) in roaming across Access Points (APs) in an Extended Service Set (ESS) may be provided. A first AP of the ESS may receive a SCS request from a station for a SCS flow. The SCS request may include a SCS identifier for the SCS flow and Quality of Service (QoS) resources requested for the SCS flow. The first AP may configure the QoS resources for the SCS flow at the first AP. A second AP of the ESS may receive a re-association request from the station in response to the station roaming to the second AP. The second AP may configure the QoS resources for the SCS flow at the second AP based on the re-association request.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Streaming traffic is among the largest and fastest growing traffic on the internet. For example, use of videoconferencing, interactive gaming, voice, Extended Reality (XR), and Internet of Things (IoT) applications over Wireless Fidelity (WiFi) is experiencing a tremendous growth. These latency sensitive applications in WiFi networks may need a robust service delivery. Stream Classification Services (SCS) may enable classification and WiFi Quality of Service (QoS) treatment of specific traffic flows allowing some traffic flows to be prioritized over other traffic flows and QoS to be met. For example, a station may send a SCS request with a QoS characteristics element to an Access Point (AP) for a Downlink (DL) traffic flow. The QoS characteristics element may be used to indicate QoS resource requirements for the traffic flow. The AP may configure the QoS characteristics for the traffic flow. Any data packets for that traffic flow may be processed based on the configured QoS characteristics.

When the station roams to another AP, the station, to configure the same QoS characteristics, may need to send a new SCS request with the QoS characteristics to the new AP, causing an unnecessary session tear down and restart. In addition, until the new SCS request is resolved and the QoS characteristics are configured at the new AP, the traffic flow may suffer. This delay in re-establishing connectivity greatly impacts QoS to the point that some upper-level protocols, such as Voice-over-IP (VoIP), may actually fail. The disclosure provides processes for the station to continue SCS in roaming across APs in an Extended Service Set (ESS).

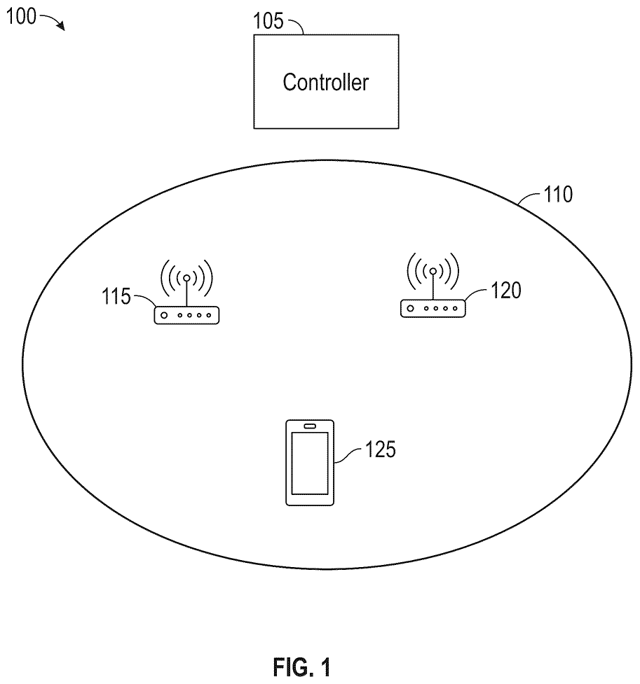

FIG. 1 shows an operating environment 100 for a method to continue SCS in roaming across APs in an ESS. As shown in FIG. 1, operating environment 100 may comprise a controller 105 and a coverage environment 110. Coverage environment 110 may comprise, but is not limited to, a Wireless Local Area Network (WLAN) comprising a plurality of APs that may provide wireless network access (e.g., access to the WLAN for client devices). The plurality of APs may include a first AP 115 and a second AP 120. The plurality of APs may provide wireless network access to station 125 as it moves within coverage environment 110.

Station 125 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the Institute of Electrical and Electronics Engineers (IEEE) 802.11 specification standard for example.

Each of first AP 115, second AP 120, and station 125 may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network (LAN) Controller (WLC) and may provision and control coverage environment 110 (e.g., a WLAN). Controller 105 may allow station 125 to join coverage environment 110. In some implementations of the disclosure, controller 105 may be implemented by a Digital Network Architecture Center (DNAC) controller (i.e., a Software-Defined Network (SDN) controller.

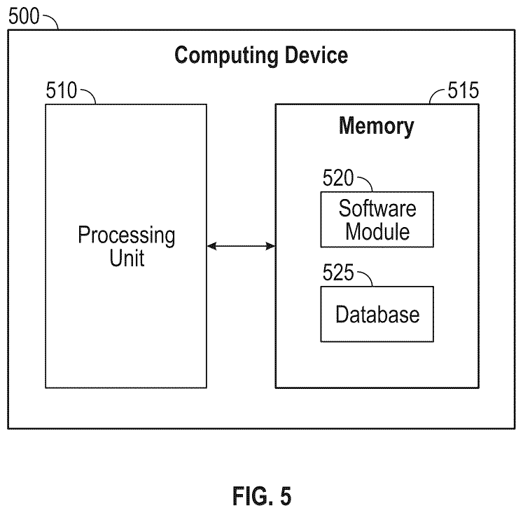

The elements described above of operating environment 100 (e.g., controller 105, first AP 115, second AP 120, or station 125) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 5, the elements of operating environment 100 may be practiced in a computing device 500.

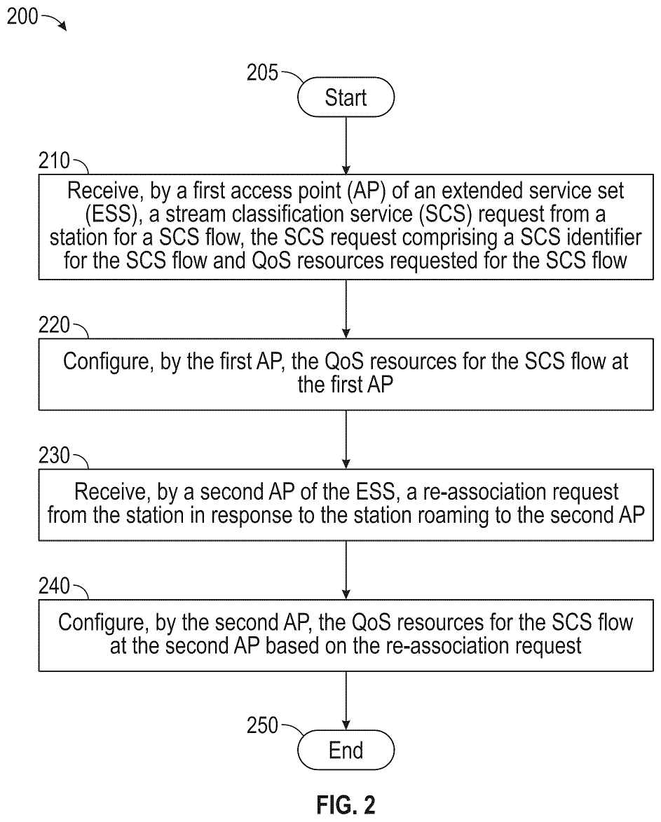

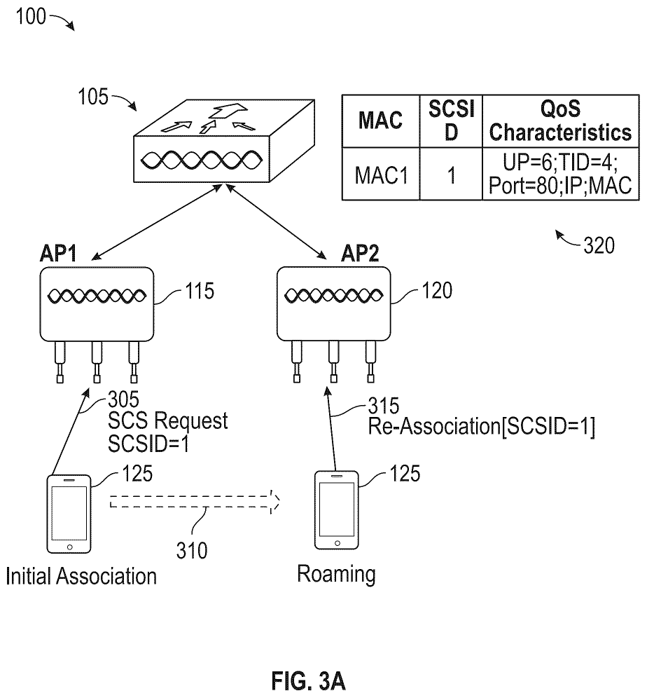

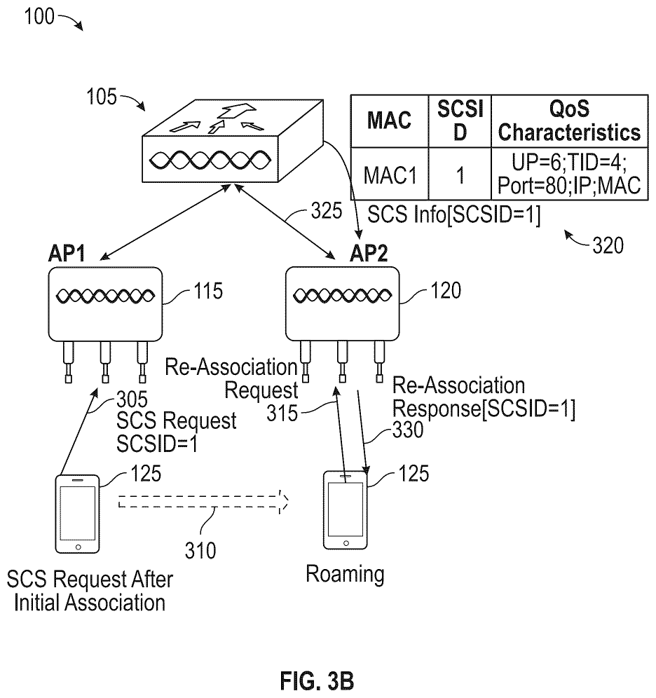

FIG. 2 is a flow chart setting forth the general stages involved in a method 200 consistent with implementations of the disclosure for method to continue SCS in roaming across APs in an ESS. Method 200 may be implemented using first AP 115, second AP 120, and station 125 as described in more detail above with respect to FIG. 1. In some implementations, method 200 may also be implemented using controller 105 as described in more detail above with respect to FIG. 1. Method 200 will be described in conjugation with FIGS. 3A and 3B. FIGS. 3A and 3B illustrate roaming of station 125 in an ESS. Ways to implement the stages of method 200 will be described in greater detail below.

Method 200 may begin at starting block 205 and proceed to stage 210 where first AP 115 of an ESS may receive a SCS request from station 125 for a SCS flow. The SCS request may be received in a SCS request frame and may include a flow identifier or a SCS Identifier (SCSID) for the SCS flow. The SCS request may also comprise QoS resources requested or QoS characteristics for the SCS flow. The QoS resources may include a bandwidth, a priority, etc.

The ESS may include first AP 115, second AP 120, station 125 that are interconnected to create a single logical network. The ESS may allow station 125 to move between first AP 115 and second AP 120 without losing its network connection. Each of first AP 115 and second AP 120 may have a Basic Service Set (BSS) associated with it. When station 125 is within a BSS, it communicates with the AP associated with that BSS. For example, and as shown in FIGS. 3A and 3B, station 125 may send a SCS request to first AP 115 (step 305) for a SCS flow. Since station 125 may be in a range of first AP 115, station 125 may send the SCS request to first AP 115. The SCS stream may be associated with an application executing on station 125. In some examples, station 125 may send multiple SCS requests for multiple SCS flows or a single SCS request for the multiple SCS flows. As discussed above, the SCS request may include a SCSID and QoS resources for each SCS flow.

Referring back to FIG. 2, after receiving the SCS request from station 125 for the SCS flow at stage 210, method 200 may proceed to stage 220 where first AP 115 may configure the QoS resources for the SCS flow at first AP 115. For example, first AP 115 may verify a network policy associated with the SCS flow and based on the verification may accept the SCS request if the network policy allows such flows. In addition, first AP 115 may assign the QoS resources requested for the SCS flow at first AP 115. Any downstream data packets for the SCS flow may be processed at first AP 115 according to the configured QoS resources at first AP 115. In example implementations, first AP 115 may allocate a Traffic Identifier (TID) and a TID-to-link mapping for the SCS flow. First AP 115 may also prioritize data packets of the SCS flow on a requested Access Category (AC).

Once having configured the QoS resources for the SCS flow at first AP 115 at stage 220, method 200 may proceed to stage 230 where second AP 120 of the ESS may receive a re-association request from station 125 in response to station 125 roaming to second AP 120. For example, and as shown in FIGS. 3A and 3B, station 125 may roam from a range (BSS) of first AP 115 to a range (BSS) of second AP 120 (step 310). When in the range of second AP 120, station 125 may send a re-association request (step 315) to second AP 120 to continue access to the network. In some implementations, and as shown in FIG. 3A, the re-association request may include the SCSID for the SCS flow. If station 125 has more than one SCS flows, then the re-association request may include the SCSID for each of these SCS flows.

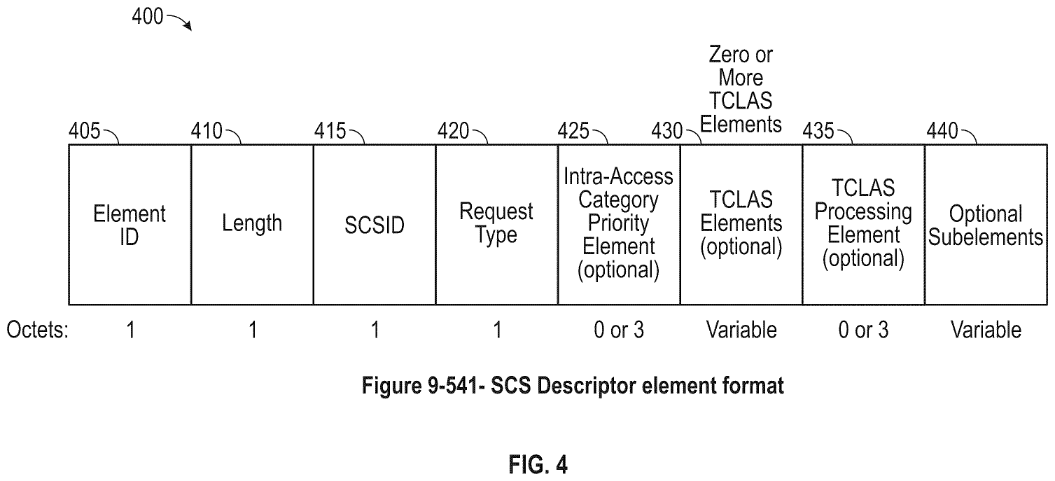

In some other implementations, the re-association request may include a SCS descriptor element. The SCS descriptor element may include SCS stream information as an Information Element (IE). FIG. 4 illustrates an example SCS descriptor element 400. As shown in FIG. 4, SCS descriptor element 400 may include an element ID field 405, a length field 410, a SCS ID field 415, a request type field 420, an intra-access category priority element (optional) field 425, a Traffic Classifier (TCLAS) elements (optional) field 430, a TCLAS processing element (optional) field 435, and an optional sub-elements field 440. Each of element ID field 405, length field 410, SCS ID field 415, and request type field 420 may be 1 octet long. Each of intra-access category priority element field 425 and TCLAS processing element field 435 may be of a fixed length, for example, 0 or 3 octet long. Each of TCLAS elements field 430 and optional sub-elements field 440 may be of a variable length.

Referring back to FIG. 2, after receiving the re-association request from station 125 for the SCS flow at stage 230, method 200 may proceed to stage 240 second AP 120 may configure the QoS resources for the SCS flow at second AP 120 based on the re-association request. For example, if the re-association request includes the SCS descriptor element as an IE, second AP 120 may program the QoS resources from the received SCS stream information in the SCS descriptor element and continue the service for the SCS flow through second AP 120. Second AP 120 may also respond with an association response including the status code for each requested SCSID. Method 200 may terminate at END stage 250.

In some implementations, and as stated above, the re-association request may only include the SCSID for the SCS flow without the TCLAS or QoS characteristic element. In such implementations, the SCS information of station 125 may be distributed in a similar fashion in which the Pairwise Master Key (PMK) cache for IEEE 802.11r is shared across APs of the ESS. For example, first AP 115 may share the SCS information associated with the QoS resources configured for the SCS flow at first AP 115 with members of the ESS, for example, controller 105 and with second AP 120. As shown in FIG. 3A, the SCS information may be shared and stored in form of a table 320 comprising a station information (for example, a Media Access Control (MAC) address), a SCSID, and QoS characteristics. The table 320 may be maintained at controller 105 or at each AP of the ESS. Second AP 120 upon receipt of the re-association request with the SCSID of the SCS flow may perform a lookup in table 320 to determine the SCS stream information associated with the SCSID.

In example embodiments, and as shown in FIG. 3B, when a re-association request is received at second AP 120, and if station 125 did not include the SCS descriptor element list in the re-association request, then second AP 120 may fetch the current negotiated SCS stream information from controller 105 or a central server where the SCS information for station 125 is stored from the previous association (step 325). Second AP 120 may configure the SCS resources from the SCS information at second AP 120, provided bandwidth is available in second AP 120. Second AP 120 may then send a re-association response to station 125 (step 330). The re-association response may include a SCS status element list comprising a new SCS element to reflect the status of the SCS flow in the re-association response. Upon the receipt of the re-association response, station 125 may program a wireless module with the SCS descriptor. If station 125 rejects the SCS descriptor element, station 125 may initiate a SCS request action frame with a delete action for the SCSID. Thus, station 125 may re-request the QoS resources for the SCS flow.

Additionally, with the SCS description element list IE, station 125 may also add QoS characteristic element for the SCS flow to use parameters to setup a Restricted-Target Wake Time (R-TWT) schedule in second AP 120 as well for continued service with the same level of guaranteed delivery as in first AP 115. This process disclosed herein may ensure the quality of service across APs within the ESS. For example, during roaming, the new AP may configure the QoS resources for the SCS flow based merely on the re-association request instead of having to wait for a new SCS request.

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform, for example, method to continue SCS in roaming across APs in an ESS as described above with respect to FIG. 2. Computing device 500, for example, may provide an operating environment for controller 105, first AP 115, second AP 120, and station 125. Controller 105, first AP 115, second AP 120, and station 125 may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 500 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving, by a first Access Point (AP) of an Extended Service Set (ESS), a Stream Classification Service (SCS) request from a station for a SCS flow, the SCS request comprising a SCS identifier for the SCS flow and Quality of Service (QoS) resources requested for the SCS flow;
configuring, by the first AP, the QoS resources for the SCS flow at the first AP;
receiving, by a second AP of the ESS, a re-association request from the station in response to the station roaming to the second AP; and
configuring, by the second AP, the QoS resources for the SCS flow at the second AP based on the re-association request.

2. The method of claim 1, wherein the re-association request comprises a SCS descriptor element comprising the QoS resources for the SCS flow.

3. The method of claim 2, wherein the SCS descriptor element is sent in an Information Element (IE) of the re-association request.

4. The method of claim 1, wherein the re-association request comprises a SCS identifier for the SCS flow, and wherein the second AP is configured to receive the QoS resources for the SCS flow based on the SCS identifier from a controller.

5. The method of claim 1, further comprising:
providing a response to the station for the re-association request, the response comprising a status of configuration of the QoS resources for the SCS flow at the second AP.

6. The method of claim 1, further comprising:
receiving, by the second AP, another SCS request to the first AP, the another SCS request comprising a delete action for the QoS resources configured at the second AP.

7. The method of claim 1, further comprising:
sharing, by the first AP, the QoS resources configured for the SCS flow at the first AP with members of the ESS.

8. A system comprising:
a memory storage; and
a processing unit coupled to the memory storage, wherein the processing unit is operative to:
receive a Stream Classification Service (SCS) request from a station for a SCS flow, the SCS request comprising a SCS identifier for the SCS flow and Quality of Service (QoS) resources requested for the SCS flow;
configuring the QoS resources for the SCS flow at a first Access Point (AP) of an Extended Service Set (ESS);
receive a re-association request from the station in response to the station roaming to a second AP of the ESS; and
configure the QoS resources for the SCS flow at the second AP based on the re-association request.

9. The system of claim 8, wherein the re-association request comprises a SCS descriptor element comprising the QoS resources for the SCS flow.

10. The system of claim 9, wherein the SCS descriptor element is sent in an Information Element (IE) of the re-association request.

11. The system of claim 8, wherein the re-association request comprises a SCS identifier for the SCS flow, and wherein the second AP is configured to receive the QoS resources for the SCS flow based on the SCS identifier from a controller.

12. The system of claim 8, wherein the processing unit is further operative to:
provide a response to the station for the re-association request, the response comprising a status of configuration of the QoS resources for the SCS flow at the second AP.

13. The system of claim 8, wherein the processing unit is further operative to:
receive another SCS request to the first AP, the another SCS request comprising a delete action for the QoS resources configured at the second AP

14. The system of claim 8, wherein the processing unit is further operative to:
share the QoS resources configured for the SCS flow at the first AP with members of the ESS.

15. A non-transitory computer-readable medium that stores a set of instructions which when executed perform a method executed by the set of instructions comprising:
receiving, by a first Access Point (AP) of an Extended Service Set (ESS), a Stream Classification Service (SCS) request from a station for a SCS flow, the SCS request comprising a SCS identifier for the SCS flow and Quality of Service (QoS) resources requested for the SCS flow;
configuring, by the first AP, the QoS resources for the SCS flow at the first AP;
receiving, by a second AP of the ESS, a re-association request from the station in response to the station roaming to the second AP; and
configuring, by the second AP, the QoS resources for the SCS flow at the second AP based on the re-association request.

16. The non-transitory computer-readable medium of claim 15, wherein the re-association request comprises a SCS descriptor element comprising the QoS resources for the SCS flow.

17. The non-transitory computer-readable medium of claim 16, wherein the SCS descriptor element is sent in an Information Element (IE) of the re-association request.

18. The non-transitory computer-readable medium of claim 15, wherein the re-association request comprises a SCS identifier for the SCS flow, and wherein the second AP is configured to receive the QoS resources for the SCS flow based on the SCS identifier from a controller.

19. The non-transitory computer-readable medium of claim 15, wherein the method executed by the set of instructions further comprising:
providing a response to the station for the re-association request, the response comprising a status of configuration of the QoS resources for the SCS flow at the second AP.

20. The non-transitory computer-readable medium of claim 15, wherein the method executed by the set of instructions further comprising:
receiving, by the second AP, another SCS request to the first AP, the another SCS request comprising a delete action for the QoS resources configured at the second AP.
